(19) United States
(12) Patent Application Publication
(10) Pub. No.: US 2026/0244621 A1
(43) Pub. Date: Aug. 20, 2026

(54) SYSTEMS AND METHODS FOR REDUCING DATA STORAGE REQUIREMENTS ACROSS COMPUTER NETWORKS

(71) Applicant: Capital One Services, LLC, McLean, VA (US)

(72) Inventor: David JACKSON, Santa Monica, CA (US)

(73) Assignee: Capital One Services, LLC, McLean, VA (US)

(21) Appl. No.: 19/059,239

(22) Filed: Feb. 20, 2025

(51) Int. Cl. G06F 16/2455; G06F 16/215

(52) U.S. Cl. CPC G06F 16/24552; G06F 16/215; G06F 16/24562

(57) ABSTRACT

Systems and methods for reducing data storage requirements across computer networks. For example, the system may receive, from a first vector database, a first vector chunk. The system may store, in a first vector cache, the first vector chunk. The system may receive a first processing request. While the first vector chunk is in the first vector cache, the system may retrieve a first usage trigger from the first vector chunk, wherein the first usage trigger indicates a first condition for using the first vector chunk. The system may determine, by a vector cache manager, whether to subject the first vector chunk to the first processing request based on the first usage trigger. The system may execute the first processing request using the first vector chunk based on determining to subject the first vector chunk to the first processing request.

### BACKGROUND

Modern databases are structured to handle higher computational demands for storage by leveraging a combination of distributed architectures, advanced indexing techniques, and optimized storage mechanisms. Distributed databases spread data across multiple servers, often in different geographic locations, to ensure scalability, fault tolerance, and high availability. This design allows them to handle large volumes of data and high query loads efficiently. Many databases also adopt hybrid storage systems, combining traditional disk-based storage with in-memory data processing to accelerate access to frequently used data. Advanced indexing techniques, such as B-trees, hash indexes, and columnar storage, further enhance data retrieval speeds, even for massive datasets. Additionally, databases are increasingly incorporating features like sharding, which divides data into smaller, more manageable chunks, and partitioning, which organizes data based on predefined criteria to optimize performance. Modern databases often integrate with cloud platforms, enabling elastic scaling and leveraging object storage solutions for cost-effective, durable, and scalable data storage. Technologies like NoSQL databases are designed to handle unstructured and semi-structured data types, accommodating the diverse needs of modern applications like real-time analytics, machine learning, and IoT. These architectural innovations ensure that modern databases can meet the growing demands of today's data-driven world.

### SUMMARY

Systems are described herein for novel uses and/or improvements to reducing data storage requirements across computer networks. As one example, systems and methods are described herein for improvements to data storage in vector databases. A vector database may be a specialized type of database designed to store, index, and query vector representations of data. Vectors are numeric arrays that encapsulate features or characteristics of data, often generated through machine learning models, such as embeddings for text, images, audio, or other types of unstructured data. These representations allow for the measurement of similarity between data points using mathematical techniques like cosine similarity or Euclidean distance. Vector databases are widely used in applications that require efficient similarity searches, such as recommendation systems, natural language processing, image recognition, and personalized content delivery. They excel in scenarios where traditional databases struggle, particularly when dealing with high-dimensional, unstructured, or semantically rich data.

Nonetheless, k-Nearest Neighbor (kNN) and approximate Nearest Neighbor (aNN) algorithms are computationally expensive for vector similarity searches due to the inherent complexity of comparing high-dimensional vectors. For example, these algorithms calculate the similarity or distance between a query vector and all stored vectors, which becomes increasingly costly as the number of vectors and their dimensionality grow. In kNN, every stored vector is compared to the query vector using mathematical metrics like cosine similarity or Euclidean distance. This brute-force approach does not scale well for large datasets. Even aNN, which employs optimizations like clustering, tree structures, or hashing, struggles with high-dimensional data and large vector databases. Unused or irrelevant chunks in the vector database exacerbate this issue by increasing the size of the search space, leading to additional, unnecessary computations. These unused chunks, often resulting from outdated or redundant data, dilute the efficiency of indexing and retrieval processes.

In view of these technical challenges, the systems and methods describe a system for reducing data storage requirements across computer networks without degrading the data quality. The system achieves this by determining what vectors, if any, are not used for predefined period of time and cleans these vectors from the datastore. By doing so, the system does not need to process unused or irrelevant chunks leading to enhance efficiency with limited (or non-existent) data loss.

However, pruning or cleansing outdated or unused data from vector databases is challenging due to the intrinsic characteristics of vector representations and their storage mechanisms. Unlike conventional databases where data records are explicitly identifiable and deletable, vectors are abstract, high-dimensional representations of data that are often not directly linked to human-readable identifiers. This makes it difficult to pinpoint which vectors are outdated or no longer relevant. Furthermore, vectors stored in a database are typically part of complex indexing structures, such as HNSW (Hierarchical Navigable Small World) graphs or other proximity-based data structures, which are optimized for fast similarity searches. Removing vectors from these structures can disrupt the balance and connectivity of the index, degrading search performance and requiring costly re-indexing operations. Additionally, determining the relevance of a vector often involves assessing its usage patterns or its association with other vectors, which is computationally expensive and may require domain-specific logic. For example, some vectors might appear unused because they are rarely queried but could still hold critical contextual information for specific use cases.

To overcome these technical deficiencies in pruning or cleansing outdated or unused data from vector databases, systems and methods disclosed herein encode a usage trigger for each vector chunk in the vector database. This usage trigger may accompany its respective vector chunk in a cache of a system using data from the vector database. For example, each vector chunk may contain data (e.g., a chunk of text, a vector representing the vectorized chunk representation produced by an embedding model, and/or metadata like document source of the chunk), as well as the usage trigger. The usage trigger may indicate under what conditions to use (or not use) the vector chunk. Alternatively or additionally, the usage trigger may contain a pointer to an auxiliary datastore that comprises this information. For example, the usage trigger may comprise a TTL (e.g., “Time-to-Live”) key that indicates when the vector chunk should be purge from a cache of vector data from the vector database.

By caching vector chunks according to the usage triggers, frequently accessed or recently used data may be stored in a fast-access memory layer, reducing the need for repeated queries to the underlying vector database. This minimizes latency, especially in applications that require real-time or near-real-time responses, such as recommendation systems, natural language processing tasks, or image search engines. Caching these vector chunks also decreases the computational overhead associated with retrieving and processing vectors from the vector database, which is particularly valuable in scenarios involving high-dimensional data or complex similarity search algorithms like kNN or aNN. Additionally, caching these vector chunks may alleviate load on the vector database, enabling it to handle larger query volumes and extending its lifespan by reducing wear and tear. By strategically caching data that is highly relevant to current operations or frequently requested queries, systems can achieve a significant boost in efficiency, scalability, and user experience.

In some aspects, systems and methods for reducing data storage requirements across computer networks are described. For example, the system may receive, from a first vector database, a first vector chunk. The system may store, in a first vector cache, the first vector chunk. The system may receive a first processing request. While the first vector chunk is in the first vector cache, the system may retrieve a first usage trigger from the first vector chunk, wherein the first usage trigger indicates a first condition for using the first vector chunk. The system may determine, by a vector cache manager, whether to subject the first vector chunk to the first processing request based on the first usage trigger. The system may execute the first processing request using the first vector chunk, based on determining to subject the first vector chunk to the first processing request.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for vector chunk comprising a usage trigger, in accordance with one or more embodiments.

FIG. 2 shows an illustrative diagram for a cache manager for a vector database, in accordance with one or more embodiments.

FIG. 3 shows illustrative components for a system used to manage a vector cache, in accordance with one or more embodiments.

FIG. 4 shows a flowchart of the steps involved in reducing data storage requirements across computer networks, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

In Retrieval-Augmented Generation (RAG) architecture, vector databases play a critical role in managing and leveraging vector representations of information chunks generated by embedding models. The process begins by dividing information, such as text documents or unstructured data, into smaller, manageable chunks. Each chunk is then converted into a high-dimensional vector using an embedding model, which encodes the semantic meaning of the chunk. These vectors, along with metadata like source document details and chunk IDs, are stored in the vector database, which is optimized for high-dimensional vector storage and efficient similarity searches. When a user issues a query, it is transformed into a vector using the same embedding model, and the vector database is queried to identify the most similar stored vectors based on similarity metrics such as cosine similarity or Euclidean distance. The database retrieves the top-k most similar chunks, which are then passed to a generative model to produce a coherent and contextually relevant response. This approach enables real-time retrieval of semantically relevant information, making vector databases a cornerstone of RAG architecture by bridging the gap between vast knowledge repositories and generative models. It is especially valuable for applications like chatbots, personalized assistants, and domain-specific knowledge retrieval systems, where accurate and context-aware outputs are essential.

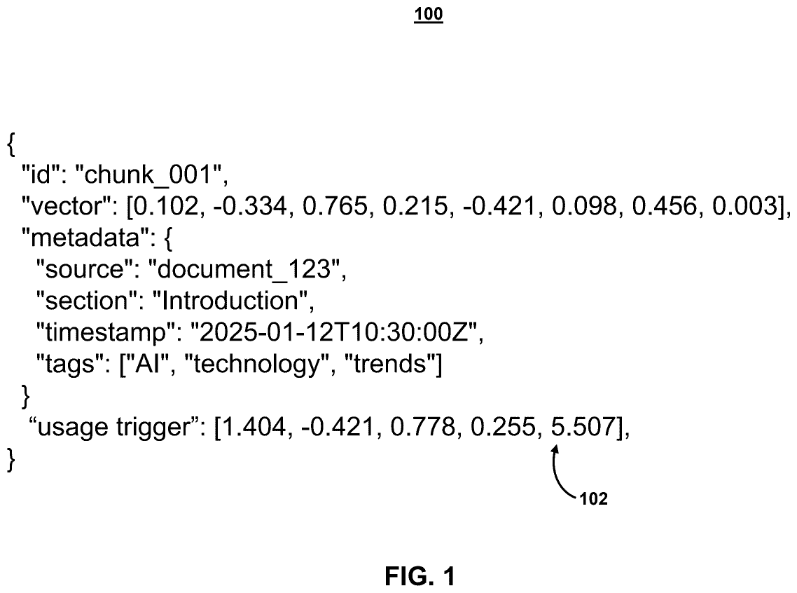

FIG. 1 shows an illustrative diagram for vector chunk comprising a usage trigger, in accordance with one or more embodiments. For example, FIG. 1 includes vector chunk 100. Vector chunk 100 may include vector data. Vector data may comprise a vector (e.g., a mathematical representation of data in the form of an ordered list of numbers, often referred to as an array or a tuple). In the context of machine learning and artificial intelligence, a vector typically represents features or attributes of data points in a numerical format that can be processed by algorithms. For example, a vector might represent the semantic meaning of a sentence, the features of an image, or the attributes of a user profile. Each element of the vector corresponds to a specific dimension, capturing some aspect of the data, such as its spatial, textual, or contextual properties. Vectors are widely used in computational tasks because they allow data to be represented in a way that facilitates operations like similarity measurement, clustering, classification, and optimization. The dimensionality of a vector—i.e., the number of elements it contains—depends on the complexity of the data and the model generating it, ranging from a few dimensions for simple tasks to hundreds or thousands for complex, high-dimensional data.

As described herein, a vector chunk (e.g., vector chunk 100) may be a segmented portion of data represented as a vector. The vector chunk may be created by dividing larger datasets, such as text documents, images, or audio files, into smaller, meaningful units. Each chunk may then be transformed into a numerical vector using an embedding model, which encodes the semantic, contextual, or structural characteristics of that chunk into a high-dimensional space. For instance, in a text-processing application, a single paragraph or sentence might be treated as a chunk, and its vector representation would encapsulate its meaning and context. Vector chunks may be used in applications that require fine-grained data retrieval or similarity searches, such as information retrieval, recommendation systems, and natural language processing. By breaking data into smaller chunks, systems can achieve higher granularity, allowing for more precise retrieval and analysis. Vector chunks may be stored in vector databases alongside metadata that provides additional context, such as the source of the chunk, its position within the larger dataset, or associated tags. The ability to work with smaller, focused representations of data makes vector chunks essential for efficient storage, retrieval, and real-time processing in AI-driven applications.

As described herein, a vector database may be a specialized database designed to store, manage, and retrieve vector representations of data. For example, vectors are high-dimensional numerical arrays generated by embedding models that encode the semantic or contextual features of data, such as text, images, audio, or video. Unlike traditional databases that organize and query structured or tabular data, vector databases are optimized for handling unstructured data by enabling efficient similarity searches and comparisons. They use advanced indexing techniques, such as HNSW (Hierarchical Navigable Small World) graphs, product quantization, or KD-trees, to quickly locate vectors that are closest to a given query vector based on similarity metrics like cosine similarity or Euclidean distance. This makes them an essential tool for applications like recommendation systems, natural language processing, image search, and other AI-driven systems where semantic relationships matter. As described herein, vector databases may support metadata storage alongside vectors, allowing for context-aware searches and filtering.

Vector chunk 100 may comprise various types of data. For example, a vector chunk may include several types of data that collectively represent and contextualize a segment of data for efficient storage, retrieval, and processing. For example, a vector chunk may contain the vector itself, a high-dimensional numerical array generated by an embedding model that encodes the semantic or contextual meaning of the chunk. Accompanying this is a chunk of text or data that the vector represents, such as a sentence, paragraph, or section of a document, which serves as the raw data linked to the vector. Additionally, the chunk includes metadata, providing contextual information about the data, such as the title of the source document, the position of the chunk within the document, tags or labels for classification, timestamps, and other attributes relevant to the application. Additionally or alternatively, the vector chunk may include source indicators, such as identifiers for the originating document, URL references, or dataset names, to trace the chunk back to its source. These components collectively enable the chunk to be used effectively in similarity searches, retrieval tasks, and AI applications, providing not just the vectorized representation but also the context necessary for meaningful analysis and response generation. This holistic inclusion of data ensures that vector chunks are both functionally rich and highly adaptable to various machine learning and information retrieval workflows.

As described above, the systems and methods describe a system for reducing data storage requirements across computer networks without degrading the data quality. The system achieves this by determining what vectors, if any, are not used for predefined period of time and cleans these vectors from the datastore (e.g., a vector cache). By doing so, the system does not need to process unused or irrelevant chunks leading to enhance efficiency with limited (or non-existent) data loss.

For example, the system can reduce data storage requirements across computer networks without degrading data quality by implementing an intelligent data lifecycle management strategy that identifies and removes unused or irrelevant vectors from the datastore, such as a vector cache. This process typically begins by monitoring access patterns to track which vectors are actively used in similarity searches or retrieval tasks over a predefined period. Vectors that are not accessed during this time are flagged as potentially irrelevant or outdated. To ensure data quality is not compromised, the system may apply additional checks, such as assessing the vector's metadata, its importance within its source context, or its association with other frequently accessed vectors. Once vectors are confirmed as unused, they are removed from the datastore, freeing up storage space and reducing the computational overhead for future queries.

This approach enhances system efficiency by focusing resources on processing only the most relevant data, reducing the time and computational power required for operations like indexing, retrieval, and similarity calculations. Advanced systems may also use machine learning to predict future vector usage based on historical trends or context, further optimizing the cleaning process. By selectively pruning unused vectors, the system achieves a balance between maintaining high-quality data and minimizing storage requirements, which is particularly beneficial in large-scale, distributed environments where resources are shared across networks. This strategy ensures that the datastore remains lean, efficient, and focused on delivering relevant, high-quality results without unnecessary computational or storage burden.

However, pruning or cleansing outdated or unused data from vector databases is challenging due to the intrinsic characteristics of vector representations and their storage mechanisms. Unlike conventional databases where data records are explicitly identifiable and deletable, vectors are abstract, high-dimensional representations of data that are often not directly linked to human-readable identifiers. This makes it difficult to pinpoint which vectors are outdated or no longer relevant. Furthermore, vectors stored in a database are typically part of complex indexing structures, such as HNSW (Hierarchical Navigable Small World) graphs or other proximity-based data structures, which are optimized for fast similarity searches. Removing vectors from these structures can disrupt the balance and connectivity of the index, degrading search performance and requiring costly re-indexing operations. Additionally, determining the relevance of a vector often involves assessing its usage patterns or its association with other vectors, which is computationally expensive and may require domain-specific logic. For example, some vectors might appear unused because they are rarely queried but could still hold critical contextual information for specific use cases.

To overcome these technical deficiencies in pruning or cleansing outdated or unused data from vector databases, systems and methods disclosed herein encode a usage trigger for each vector chunk in the vector database. This usage trigger may accompany its respective vector chunk in a cache of a system using data from the vector database. For example, each vector chunk may contain data (e.g., a chunk of text, a vector representing the vectorized chunk representation produced by an embedding model, and/or metadata like document source of the chunk) as well as the usage trigger. The usage trigger may indicate under what conditions to use (or not use) the vector chunk. Alternatively or additionally, the usage trigger may contain a pointer to an auxiliary datastore that comprises this information. For example, the usage trigger may comprise a TTL (e.g., “Time-to-Live”) key that indicates when the vector chunk should be purge from a cache of vector data from the vector database.

By caching vector chunks according to the usage triggers, frequently accessed or recently used data may be stored in a fast-access memory layer, reducing the need for repeated queries to the underlying vector database. This minimizes latency, especially in applications that require real-time or near-real-time responses, such as recommendation systems, natural language processing tasks, or image search engines. Caching these vector chunks also decreases the computational overhead associated with retrieving and processing vectors from the vector database, which is particularly valuable in scenarios involving high-dimensional data or complex similarity search algorithms like kNN or aNN. Additionally, caching these vector chunks may alleviate load on the vector database, enabling it to handle larger query volumes and extending its lifespan by reducing wear and tear. By strategically caching data that is highly relevant to current operations or frequently requested queries, systems can achieve a significant boost in efficiency, scalability, and user experience.

Vector chunk 100 comprises usage trigger 102. For example, the usage trigger for a vector chunk may be a mechanism that defines the conditions under which the vector chunk should be used, retained, or purged. This trigger can take various forms, such as metadata rules, thresholds, or external references, and it serves to optimize the efficiency and relevance of the vector chunk within the system. For example, a usage trigger may include a Time-to-Live (TTL) key, specifying a predefined duration after which the vector chunk should be purged from a cache if it has not been accessed. This ensures that storage resources are not consumed by stale or irrelevant data. Alternatively, the trigger might be based on usage frequency, where a chunk is retained only if it meets a minimum threshold of access or similarity matches within a certain period.

In some cases, the usage trigger can point to an auxiliary datastore containing additional information about the vector chunk, such as user preferences, system-specific policies, or contextual indicators that determine its relevance. For example, a trigger might reference a dataset that tracks query patterns or model updates to decide whether a vector remains critical to ongoing tasks. Triggers may also include conditions like contextual applicability (e.g., whether the vector chunk pertains to a current domain or topic) or versioning rules (e.g., purging vectors tied to outdated embedding models). By implementing such usage triggers, systems can dynamically manage vector data, maintaining a balance between efficiency and relevance while minimizing unnecessary storage and computational overhead. This approach ensures that vector chunks are only used and retained when they contribute meaningfully to the system's goals.

For example, in response to the first processing request, the system may receive, from a first vector database, a first vector chunk. The system may store, in a first vector cache, the first vector chunk. While the first vector chunk is in the first vector cache, the system may retrieve a first usage trigger from the first vector chunk, wherein the first usage trigger indicates a first condition for using the first vector chunk.

For example, the system may use a usage trigger in a vector chunk to determine the conditions under which the vector chunk should be utilized, retained, or purged, optimizing data storage and retrieval processes. For instance, the system may store a vector chunk, such as a high-dimensional numerical representation of data, in a first vector cache. While the vector chunk resides in this cache, the system retrieves the associated usage trigger embedded within the vector chunk. This usage trigger specifies a predefined condition or set of conditions, such as a Time-to-Live (TTL) duration, access frequency, or contextual relevance, that governs how and when the vector chunk should be used.

For example, if the usage trigger indicates a TTL of 24 hours, the system ensures the vector chunk remains accessible in the cache only for that duration, after which it is automatically purged unless it is accessed again or its relevance is reaffirmed. Alternatively, the usage trigger might specify conditions like the type of query that can utilize the vector chunk or a pointer to auxiliary information for contextual decisions. By evaluating these triggers dynamically, the system can efficiently manage its cache, prioritizing the storage and retrieval of high-value or frequently used data while minimizing computational overhead and storage costs. This mechanism ensures that the system remains responsive, scalable, and capable of handling evolving workloads without compromising on performance or data quality.

The usage trigger and/or condition can be encoded in the vector chunk as part of its metadata, allowing the system to dynamically determine the vector chunk's usage and lifecycle. Metadata is a flexible structure often stored alongside the vector in the database or cache, providing additional contextual and operational details. The usage trigger might include fields, such as a Time-to-Live (TTL) value, specifying how long the vector chunk remains valid in the cache before it is considered for purging. It can also include access frequency counters, recording how often the vector chunk is retrieved, or last accessed timestamps, which allow the system to evaluate recency of use for decisions like cache eviction.

Additionally, the usage trigger could encode contextual rules, such as a list of query types or conditions under which the chunk is applicable, ensuring it is only used for relevant operations. It may also contain pointers or references to external auxiliary datastores that hold more detailed rules or policies for usage, enabling complex decision-making without bloating the vector chunk itself. In some cases, the usage trigger can be embedded directly within the vector data structure or in a linked record, depending on the system architecture. Encoding these triggers ensures that the system can autonomously manage the vector chunk's lifecycle, optimizing storage, retrieval efficiency, and relevance in a resource-efficient manner.

For example, the system may determine, by a vector cache manager, whether to cleanse the first vector chunk from the first vector cache based on the first usage trigger. In response to determining not to cleanse the first vector chunk from the first vector cache based on the first usage trigger, the system may continue to store the first vector chunk in the first vector cache. While continuing to store the first vector chunk in the first vector cache, the system may receive, via a second user interface, a second processing request from a second network device of the computer network. The system may retrieve the first usage trigger from the first vector chunk and determine, by the vector cache manager, to cleanse the first vector chunk from the first vector cache based on the first usage trigger.

For example, while the vector chunk remains in the cache, the system may receive a second processing request, such as a query from a second network device via a user interface. At this point, the system retrieves the usage trigger from the vector chunk again to reassess its relevance and storage eligibility. If the evaluation of the usage trigger now indicates that the conditions for cleansing have been met—such as the TTL expiring or the chunk being deemed irrelevant due to inactivity—the system, via the cache manager, proceeds to cleanse the vector chunk from the cache. This dynamic and context-aware approach ensures that the cache retains only the most relevant and useful data, optimizing storage resources and reducing unnecessary computational overhead while still responding effectively to incoming processing requests.

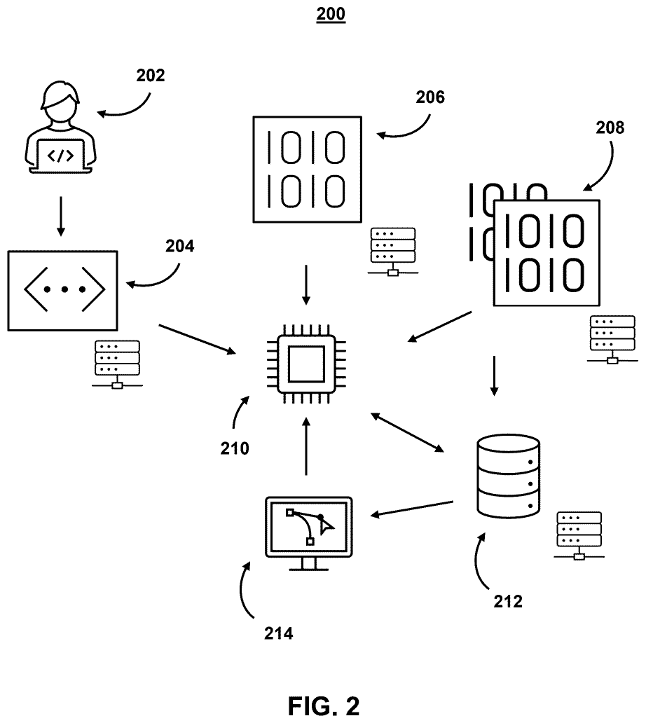

FIG. 2 shows an illustrative diagram for a cache manager for a vector database, in accordance with one or more embodiments. For example, system 200 may process a vector chunk (e.g., vector chunk 100 (FIG. 1)). FIG. 2 shows an illustrative diagram for a cache manager for a vector database, in accordance with one or more embodiments. FIG. 2 shows system 200, which may be used to reduce data storage requirements across computer networks.

System 200 may receive, via user interface 202, a first processing request (e.g., a query input) from a first network device of a computer network. As referred to herein, a “user interface” may comprise a human-computer interaction and communication in a device, and may include display screens, keyboards, a mouse, and the appearance of a desktop. For example, a user interface may comprise a way a user interacts with an application or a website.

As referred to herein, “content” should be understood to mean an electronically consumable user asset, such as Internet content (e.g., streaming content, downloadable content, Webcasts, etc.), video clips, audio, content information, pictures, rotating images, documents, playlists, websites, articles, books, electronic books, blogs, advertisements, chat sessions, social media content, applications, games, and/or any other media or multimedia and/or combination of the same. Content may be recorded, played, displayed, or accessed by user devices, but can also be part of a live performance. Furthermore, user generated content may include content created and/or consumed by a user. For example, user generated content may include content created by another, but consumed and/or published by the user.

The system may monitor content generated by the user to generate user profile data. As referred to herein, “a user profile” and/or “user profile data” may comprise data actively and/or passively collected about a user. For example, the user profile data may comprise content generated by the user and a user characteristic for the user. A user profile may be content consumed and/or created by a user.

User profile data may also include a user characteristic. As referred to herein, “a user characteristic” may include information about a user and/or information included in a directory of stored user settings, preferences, and information for the user. For example, a user profile may have the settings for the user's installed programs and operating system. In some embodiments, the user profile may be a visual display of personal data associated with a specific user, or a customized desktop environment. In some embodiments, the user profile may be digital representation of a person's identity. The data in the user profile may be generated based on the system actively or passively monitoring. In some embodiments, the system may link a usage trigger to a user profile and/or user characteristic.

System 200 may encode the query input (e.g., received via user interface 202) at query encoder 204. Query encoder 204 may check vector cache 210 (e.g., a Least Recently Used (LRU) cache). Cache manager 206 may manage vector cache 210. Cache sync manager 208 may invalidate vector cache 210 (e.g., based on data integrity) and monitor updates to vector database 212. Vector database 212 may store results in vector cache 210 and may query vector database 212 for missed cache data. Vector database 212 may issue outputs 214. Outputs 214 may also be received from vector cache 210.

For example, system 200 may facilitate reduced data storage and improved efficiency by leveraging a vector cache to handle frequent queries and minimize unnecessary database access. For example, system 200 may receive a processing request (e.g., a query input). When a query input is received, for example via user interface 202, it may be processed by query encoder 204 to generate a vector representation of the input. A query input may be the information or data provided to a system by a user or an application to request specific results, insights, or actions. In the context of systems like search engines, recommendation systems, or vector databases, a query input may be a text string, image, audio snippet, or other data formats that the system processes to generate relevant outputs. For example, in a search engine, a query input could be a phrase like “best restaurants near me,” while in an image retrieval system, it could be an uploaded picture. The query input may be preprocessed by the system, such as being tokenized, normalized, or transformed into a numerical representation (e.g., a vector) by a query encoder (e.g., query encoder 204) or an embedding model. This transformation enables the system to perform tasks like similarity searches, filtering, or ranking relevant results. Query inputs are central to the functionality of interactive systems, as they serve as the starting point for extracting meaningful and context-aware responses that meet the user's needs.

The query encoder first checks vector cache 210, which may be implemented as a Least Recently Used (LRU) cache, to see if a similar or identical vector already exists. For example, a vector cache may be a temporary storage layer designed to hold frequently accessed or recently used vector representations of data, enabling faster retrieval and reducing the computational load on the underlying vector database. By caching these vectors, the system can avoid repeatedly querying the vector database for identical or similar requests, significantly improving performance, particularly in real-time applications like recommendation systems, natural language processing, or image search. A vector cache is typically managed by a caching mechanism, such as a Least Recently Used (LRU) policy, which ensures that only the most relevant or frequently accessed vectors are retained while older, less-used vectors are removed to optimize storage. In some implementations, a vector cache may also store metadata or query results alongside the vectors, enabling faster context-aware retrieval. This intermediate layer not only accelerates response times but also alleviates the load on the primary database, enhancing the scalability and efficiency of the overall system. By strategically managing the storage and retrieval of vectors, a vector cache plays a vital role in maintaining high performance in AI-driven applications.

If a vector chunk is found in the cache, the result is returned directly from the cache, reducing the need for a database query. Cache manager 206 oversees the vector cache, ensuring that it efficiently stores and retrieves frequently used vectors while adhering to storage constraints. To maintain the integrity and relevance of the vector cache, cache sync manager 208 invalidates outdated or stale cache entries based on data integrity checks and monitors updates to vector database 212. This ensures that the cached data remains consistent with the database, avoiding discrepancies that could lead to inaccurate outputs. If the cache does not contain the required vector (a cache miss), the system queries vector database 212 to retrieve the necessary data, stores the result in the vector cache for future use, and provides output 214 to the user. By returning results from either the vector cache or the vector database, the system optimizes response times and reduces the computational load on the database. This architecture effectively balances real-time performance with storage efficiency, ensuring that the system meets high-demand requirements without degrading data quality or integrity.

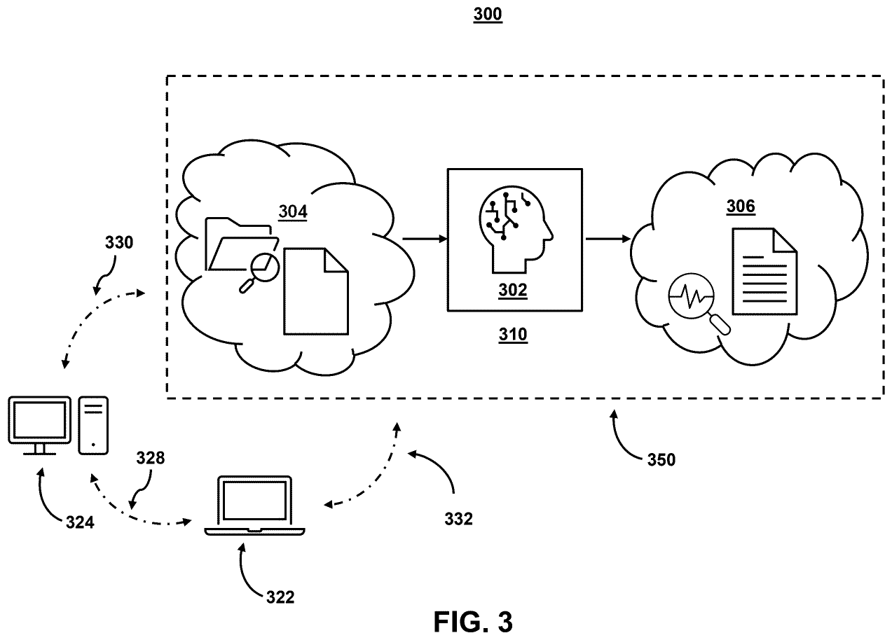

FIG. 3 shows illustrative components for a system used to manage a vector cache, in accordance with one or more embodiments. For example, FIG. 3 may show illustrative components for reducing data storage requirements across computer networks. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

In some embodiments, system 300 and/or one or more models herein may be implemented using an application specific integrated circuit. An integrated circuit may be a small electronic device made of semiconductor material, typically silicon, that contains a large number of microscopic electronic components such as transistors, resistors, capacitors, and diodes. These components are interconnected to perform a specific function or set of functions. Integrated circuits can be classified into various types based on their functionality, such as analog, digital, and mixed-signal ICs. The transistors within an IC are the primary building blocks, as they act as switches or amplifiers for electronic signals. The other components, like resistors and capacitors, are used for controlling voltage, current, and timing within the circuit. System 300 may design the integrated circuit to be application specific such that design of the circuit is customized for a given application. In some embodiments, system 300 may use an integrated circuit system where one or more integrated circuit are spread throughout a system, network, and/or one or more devices. In such case, the system design may ensure that the circuits are integrated with other electronic components like connectors, power supplies, and sensors to form a complete and functional electronic system. This integration allows for the implementation of sophisticated tasks in devices needed for one or more specified applications.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may, separately or together, include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). In recent years, the use of artificial intelligence, including, but not limited to, machine learning, deep learning, etc. (referred to collectively herein as artificial intelligence models, machine learning models, or simply models) has exponentially increased. Broadly described, artificial intelligence refers to a wide-ranging branch of computer science concerned with building smart machines capable of performing tasks that typically require human intelligence. Key benefits of artificial intelligence are its ability to process data, find underlying patterns, and/or perform real-time determinations. However, despite these benefits and despite the wide-ranging number of potential applications, practical implementations of artificial intelligence have been hindered by several technical problems. First, artificial intelligence may rely on large amounts of high-quality data. The process for obtaining this data and ensuring it is high-quality can be complex and time-consuming. Additionally, data that is obtained may need to be categorized and labeled accurately, which can be difficult, time-consuming and a manual task. Second, despite the mainstream popularity of artificial intelligence, practical implementations of artificial intelligence may require specialized knowledge to design, program, and integrate artificial intelligence-based solutions, which can limit the amount of people and resources available to create these practical implementations. Finally, results based on artificial intelligence can be difficult to review as the process by which the results are made may be unknown or obscured. This obscurity can create hurdles for identifying errors in the results, as well as improving the models providing the results.

Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., usage triggers, condition interpretations, data integrity protocols, encodings for vector chunks, etc.).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., usage triggers, condition interpretations, data integrity protocols, encodings for vector chunks, etc.). In some embodiments, the model (e.g., model 302) may automatically perform actions based on outputs 306. In some embodiments, the model (e.g., model 302) may not perform any actions. The output of the model (e.g., model 302) may be used to reduce storage requirements.

In some embodiments, the system may generate predictions related to financial services. For example, the system may use one or more models and/or application to process a variety of data to generate predictions for tasks such as payment card eligibility determinations, fraud detection, and/or determining rates for auto-finance applications. For credit card eligibility, the model may use data such as the applicant's credit score, income, employment history, debt-to-income ratio, and past credit history. This data helps the model predict the likelihood of the applicant repaying the credit card debt. For fraud detection, models analyze transaction data, including the amount, location, frequency, and pattern of transactions. They compare these patterns to known fraudulent behavior to identify potentially fraudulent activities. For determining auto-finance rates, models might use the applicant's credit score, loan amount, loan term, vehicle details, and market interest rates. The data used by these models comes from various sources, including credit bureaus, financial institutions, customer-provided information, transaction records, and public records. By analyzing these data points, models can make informed predictions and decisions that help financial institutions manage risk, provide appropriate services, and enhance customer satisfaction.

In some embodiments, the model may process received data through several stages. For example, the model may collect and aggregate data from various sources (e.g., a user account, industry data, third-party data sources, etc.). The system may ensure the data is cleaned and preprocessed to handle any missing and/or inconsistent information. This preprocessing may include normalizing numerical data, encoding categorical variables, and applying techniques to handle outliers. The model may then use feature engineering to identify and create relevant features that can improve its predictive power. For instance, the system may derive new variables from existing ones, such as calculating the debt-to-income ratio from debt and income data.

Once the data is prepared, the system feeds the data into the model, which could be an artificial intelligence algorithm such as logistic regression, decision trees, and/or neural networks. The model may be trained on historical data, learning patterns, and/or relationships between input features and the target outcomes. During this training process, the system may adjust the model parameters to minimize prediction errors. After training, the system may validate the model and test the model using separate data sets to ensure the model has a predetermined and/or threshold accuracy and generalizability.

In some embodiments, the system may use specialized predictions based on the task. Additionally or alternatively, the system may adjust the inputs and/or outputs based on the determinations and/or predictions required. For example, for credit card eligibility, the model may evaluate the applicant's likelihood of defaulting on payments. In fraud detection, the model may identify anomalies and patterns indicative of fraudulent behavior. In auto-finance rate determination, the model may predict the risk associated with lending to an individual and adjusts the interest rates accordingly. In some embodiments, the entire process may be iterative, with models continually updated and refined as new data becomes available, ensuring they remain effective in making accurate and reliable predictions.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open-source API Platforms and their modules. API layer 350 may use a developer portal. API layer 350 may use strong security constraints applying WAF and DDOS protection, and API layer 350 may use RESTful APIs as standard for external integration.

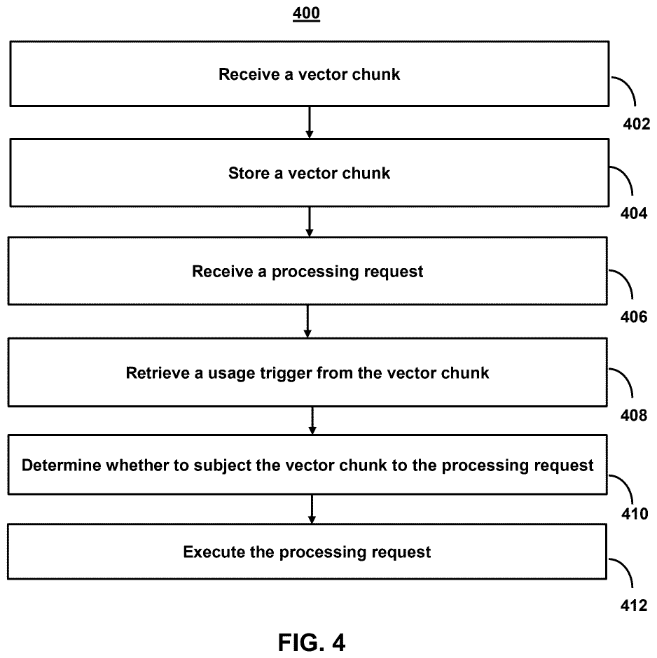

FIG. 4 shows a flowchart of the steps involved in reducing data storage requirements across computer networks, in accordance with one or more embodiments. For example, the system may use process 400 (e.g., as implemented on one or more system components described above) in order to use a vector chunk comprising a usage trigger for cache management.

At step 402, process 400 (e.g., using one or more components described above) receives a vector chunk. For example, the system may receive, from a first vector database, a first vector chunk. The system may receive a first vector chunk from a vector database through a query or retrieval request that matches specific conditions or criteria. The process may begin when the system issues a query to the vector database, such as a similarity search based on a vectorized representation of user input or a direct request for a specific chunk by its identifier. The vector database processes this query using its indexing mechanism, which may involve techniques like HNSW graphs, product quantization, or other optimized search algorithms to quickly locate the relevant vector chunk.

At step 404, process 400 (e.g., using one or more components described above) stores the vector chunk. For example, the system may store, in a first vector cache, the first vector chunk. For example, once identified, the system may retrieve the vector chunk, which includes the high-dimensional vector representation along with associated metadata, such as the source information, chunk ID, or context details. The system may then receive the retrieved vector chunk and may store it temporarily in a vector cache for quick access during subsequent operations. This interaction ensures that the system can efficiently retrieve the precise data needed for further processing, such as similarity comparisons, relevance ranking, or response generation, while leveraging the capabilities of the vector database to handle large-scale, high-dimensional datasets effectively.

At step 406, process 400 (e.g., using one or more components described above) receives a processing request. For example, the system may receive a first processing request when a user or another system sends an input or command through an interface or communication channel designed for interaction. This input can take various forms, such as a text query, an API call, a file upload, or a real-time signal from a connected device. The request is typically routed through a user interface, such as a web or mobile application, or through system interfaces like RESTful APIs or messaging protocols. Once the request reaches the system, it is parsed and processed to extract relevant parameters or data required for execution. For example, in a search application, the processing request might include a query string and user preferences, while in an image processing system, it might involve an uploaded image and associated metadata. The system validates the request to ensure it conforms to expected formats and includes all necessary information. It then passes the processed input to the appropriate internal module, such as a query encoder, database manager, or computational engine, to execute the requested operation. This structured approach allows the system to handle diverse processing requests efficiently while maintaining robustness and scalability.

At step 408, process 400 (e.g., using one or more components described above) retrieves a usage trigger from the vector chunk. For example, the system may, while the first vector chunk is in the first vector cache, retrieve a first usage trigger from the first vector chunk, wherein the first usage trigger indicates a first condition for using the first vector chunk. While the first vector chunk resides in the first vector cache, the system can retrieve a first usage trigger embedded within or associated with the vector chunk to determine its conditions for use. The vector chunk typically includes metadata, where the usage trigger is stored as a key-value pair, tag, or reference. When the system needs to evaluate the vector chunk's relevance or suitability for a specific operation, it accesses the metadata through the vector cache manager. This retrieval process involves querying the cache for the specific chunk using its unique identifier or other indexing mechanisms. Once the vector chunk is located, the system extracts the usage trigger, which could specify conditions such as a Time-to-Live (TTL), minimum access frequency, or applicability for specific query types or contexts. By analyzing the retrieved usage trigger, the system determines whether the vector chunk meets the required conditions for continued use or relevance to the current processing request. This dynamic retrieval of usage triggers ensures efficient cache management and ensures that vector chunks are utilized optimally, enhancing system performance and responsiveness.

In some embodiments, the system may retrieve the first usage trigger from the first vector chunk, wherein the first usage trigger indicates the first condition for using the first vector chunk by parsing source code of the first vector chunk and identifying the first condition in the source code. For example, the system may retrieve the first usage trigger from the first vector chunk by parsing the source code or metadata associated with the vector chunk and identifying the condition that governs its use. The process begins when the system accesses the stored representation of the first vector chunk, which may include a combination of the vector data and additional information encoded in its metadata or accompanying source code. The source code or metadata is structured to include usage triggers, such as Time-to-Live (TTL) values, allowed usage scenarios, or retention priorities, often formatted as key-value pairs, annotations, or embedded comments. The system parses this source code or metadata using a designated parser or a metadata extraction module. During parsing, the system scans for predefined markers or keys that denote usage conditions, such as “ttl,” “allowed_usage,” or “retention_priority.” Once these markers are identified, the system extracts the associated values to determine the specific condition for using the vector chunk. For example, if the source code contains a TTL field with a timestamp or duration, the system interprets this as the first condition for usage. By systematically analyzing the source code of the vector chunk, the system ensures that it accurately identifies the usage trigger and retrieves the necessary condition. This process allows the system to enforce data management policies dynamically, ensuring that the vector chunk is used only in appropriate contexts and in compliance with its predefined conditions. Parsing the source code provides a reliable and scalable method for retrieving usage triggers, especially in environments where vector chunks carry complex or customized usage rules.

In some embodiments, the system may retrieve the first usage trigger from the first vector chunk, wherein the first usage trigger indicates the first condition for using the first vector chunk by parsing source code of the first vector chunk and identifying a first pointer in the source code, wherein the first pointer references an auxiliary database comprising the first condition. For example, the system may retrieve the first usage trigger from the first vector chunk by parsing its source code to locate a pointer that references an auxiliary database where the first condition is stored. The process begins with the system accessing the representation of the first vector chunk, which includes the vector data and associated metadata or source code. Using a designated parser, the system analyzes the source code, scanning for markers or fields that act as pointers to external data sources. These pointers could take the form of URLs, database keys, or file paths embedded within the source code or metadata structure. Once the system identifies the pointer, it interprets it as a reference to an auxiliary database containing additional information about the vector chunk's usage trigger. The system then uses the pointer to query the auxiliary database, accessing the relevant entry associated with the vector chunk. This entry includes the first condition, such as a Time-to-Live (TTL) value, access permissions, contextual applicability, or retention priority. By retrieving this condition from the auxiliary database, the system obtains the necessary usage trigger to determine how the vector chunk should be used, retained, or processed. This approach allows the system to maintain a lightweight structure for the vector chunk itself while enabling flexible and scalable management of usage rules in the auxiliary database. By dynamically retrieving conditions via pointers, the system ensures accurate enforcement of policies, efficient resource utilization, and adaptability to changes in data usage requirements.

In some embodiments, the system may retrieve the first usage trigger from the first vector chunk, wherein the first usage trigger indicates the first condition for using the first vector chunk by parsing source code of the first vector chunk, identifying a first rule in the source code, and executing the first rule to determine the first condition. For example, the system may retrieve the first usage trigger from the first vector chunk by parsing its source code to identify and execute a rule embedded within the chunk's metadata or logic. The process begins with the system accessing the representation of the first vector chunk, which includes its vector data and accompanying source code or metadata. Using a designated parser, the system analyzes the source code to locate a specific rule or directive that defines or generates the usage condition. This rule could be a function, conditional statement, or logic expression encoded within the source. Once the system identifies the rule, it evaluates or executes it to determine the first condition for using the vector chunk. For example, the rule might specify a Time-to-Live (TTL) calculation based on the vector chunk's creation timestamp, or it could include logic for validating the vector chunk's relevance by comparing current parameters (e.g., query type, context, or frequency of use) against predefined thresholds. By executing the rule, the system dynamically derives the first usage trigger, which serves as the condition for the vector chunk's use in subsequent operations. This approach enables the system to retrieve usage conditions that are contextually or dynamically defined, providing flexibility in how the vector chunk is managed. By embedding executable rules within the source code, the system can adapt to evolving requirements and ensure that decisions regarding the vector chunk's usage are accurate, timely, and aligned with the intended purpose. This dynamic rule execution ensures efficient data handling while maintaining consistency with predefined usage policies.

In some embodiments, the system may retrieve a first usage trigger from the first vector chunk, wherein the first usage trigger indicates the first condition for using the first vector chunk by parsing source code of the first vector chunk and identifying a first characteristic in the source code to determine the first condition. For example, the system may retrieve a first usage trigger from the first vector chunk by parsing the source code associated with the vector chunk and identifying a characteristic within the code that determines the first condition for its use. The process begins with the system accessing the vector chunk, which includes its high-dimensional vector data along with metadata or embedded source code containing usage-related information. Using a parser or metadata extraction tool, the system scans the source code for specific characteristics, such as predefined fields, annotations, or variables that indicate conditions for usage. For instance, the source code may include characteristics like a “ttl” (Time-to-Live) field, an “allowed_operations” list, or a “priority” flag, each representing a usage-related attribute. The system identifies these characteristics by matching them against a predefined schema or set of recognized keys and values. Once the relevant characteristic is found, the system interprets it to determine the first usage condition. For example, a “ttl” field might specify an expiration time, while an “allowed_operations” list could define the types of requests the vector chunk can handle. By identifying and interpreting these characteristics in the source code, the system dynamically determines the conditions under which the vector chunk can be used. This approach ensures flexibility and adaptability, allowing the system to enforce usage policies effectively while supporting the efficient processing of vector data. Parsing source code for characteristics provides a scalable method to manage diverse usage triggers across varying data structures and use cases.

In some embodiments, the system may retrieve the first usage trigger from the first vector chunk, wherein the first usage trigger indicates the first condition for using the first vector chunk by parsing source code of the first vector chunk, identifying a first data source in the source code, and using the first data source to determine the first condition. For example, the system may retrieve the first usage trigger from the first vector chunk by parsing its source code to identify a data source referenced within the code and using that data source to determine the first condition for using the vector chunk. The process begins with the system accessing the vector chunk, which includes its vector representation along with source code or metadata. The system employs a parser to analyze the source code, scanning for elements that reference an external or internal data source. These references might take the form of database keys, URLs, file paths, or API endpoints embedded in the code. Once the parser identifies the first data source, the system interprets the reference and queries or retrieves information from the specified data source. This data source could contain dynamically updated information, such as Time-to-Live (TTL) values, usage policies, access permissions, or contextual relevance metrics associated with the vector chunk. By accessing the data source, the system extracts the information required to determine the first condition for using the vector chunk. For example, the data source might indicate that the chunk is valid for specific query types, has an expiration time, or is linked to a specific domain or context. By leveraging the identified data source, the system dynamically retrieves and applies the first usage trigger to evaluate the vector chunk's relevance and applicability for a given processing request. This approach provides flexibility, as the conditions for usage are not static but can be updated or maintained externally, ensuring that the system remains adaptable and efficient in managing vector data. Parsing source code to identify and use data sources enhances scalability and supports the seamless integration of complex usage policies.

At step 410, process 400 (e.g., using one or more components described above) determines whether to subject the vector chunk to the processing request. For example, the system may determine, by a vector cache manager, whether to subject the first vector chunk to the first processing request based on the first usage trigger. The system may determine, through the vector cache manager, whether to subject the first vector chunk to the first processing request by evaluating the conditions specified in the first usage trigger. When the processing request is received, the vector cache manager locates the relevant vector chunk in the cache and retrieves its usage trigger, which may include parameters such as a Time-to-Live (TTL), access frequency thresholds, contextual applicability, or other predefined rules. The cache manager then compares these conditions against the specifics of the processing request. For example, if the usage trigger includes a TTL and the chunk's expiration time has passed, the manager may deem the chunk invalid for the request. Alternatively, if the usage trigger specifies a required query type or context and the request does not meet these criteria, the chunk may be excluded from processing. On the other hand, if all conditions in the usage trigger are satisfied—such as the chunk being recent, relevant, and meeting context requirements—the manager allows the chunk to be used for the processing request. This systematic evaluation ensures that the system only processes vector chunks that are valid and relevant, optimizing performance and maintaining data integrity.

In some embodiments, the system may determine whether to subject the first vector chunk to the first processing request, based on the first usage trigger, by determining an expiration date for the first vector chunk based on the first condition and comparing the expiration date to a current date. For example, the system may retrieve the usage trigger associated with the first vector chunk, which may include a Time-to-Live (TTL) value, creation timestamp, or a predefined expiration date. Using this information, the system calculates the expiration date for the vector chunk by adding the TTL value to the chunk's creation timestamp or directly retrieving the stored expiration date from the metadata. Once the expiration date is determined, the system compares it to the current date and time. If the current date falls after the expiration date, the system concludes that the first vector chunk has expired and is no longer valid for use. In this case, the chunk is excluded from the processing request, and the system may initiate a cleansing operation to remove it from the cache. Conversely, if the current date is within the valid range of the expiration date, the system determines that the vector chunk remains relevant and includes it in the processing request. This evaluation ensures that only fresh and contextually valid data is used, optimizing the system's performance and maintaining data accuracy. By dynamically managing vector chunks based on expiration conditions, the system ensures efficient resource utilization and consistent handling of time-sensitive data.

In some embodiments, the system may determine whether to subject the first vector chunk to the first processing request based on the first usage trigger by determining an allowed use for the first vector chunk, based on the first condition and comparing the allowed use to the first processing request. The system may retrieve the usage trigger associated with the vector chunk, which defines conditions for its use. These conditions may include parameters such as the type of operation the vector chunk is authorized for, specific query contexts, or domain constraints. For example, the usage trigger might specify that the vector chunk is only valid for similarity searches, text processing tasks, or specific categories of user queries. Once the allowed use is identified, the system compares it to the nature of the first processing request. If the processing request aligns with the allowed use—for instance, if the request involves a similarity search and the vector chunk is authorized for this operation—the system determines that the vector chunk can be used for the request. Conversely, if the processing request falls outside the allowed use specified in the usage trigger, such as attempting to apply the vector chunk in an unrelated task or domain, the system excludes the chunk from the processing flow. This comparison ensures that vector chunks are only subjected to processing requests that align with their intended purpose or constraints, maintaining both the integrity and relevance of the data. By dynamically assessing allowed use based on usage triggers, the system optimizes its operations, reduces errors, and ensures compliance with predefined data usage policies.

In some embodiments, the system may determine whether to subject the first vector chunk to the first processing request based on the first usage trigger by determining a threshold number of uses allowed for the first vector chunk based on the first condition and comparing the threshold number of uses to a previous number of uses of the first vector chunk. For example, the system may determine whether to subject the first vector chunk to the first processing request by evaluating its usage trigger, specifically focusing on a threshold number of allowed uses. The system retrieves the usage trigger associated with the first vector chunk, which includes a condition defining the maximum number of times the vector chunk can be used. This threshold might be set based on factors such as the relevance of the vector chunk to specific tasks, its computational cost, or the likelihood of becoming outdated after repeated use. The system then compares the threshold number of allowed uses to the actual number of times the vector chunk has already been used, which is tracked in the metadata of the chunk. If the previous number of uses is below the threshold, the system determines that the vector chunk is still eligible for processing and subjects it to the first processing request. Conversely, if the previous number of uses meets or exceeds the threshold, the system concludes that the vector chunk has reached its usage limit and excludes it from the processing request. This dynamic evaluation ensures that vector chunks are not overused or applied beyond their intended lifespan, maintaining the efficiency and relevance of the system. By managing the lifecycle of vector chunks based on usage thresholds, the system optimizes resource utilization, prevents performance degradation, and ensures that data remains contextually accurate and appropriate for ongoing operations.

In some embodiments, the system may determine whether to subject the first vector chunk to the first processing request based on the first usage trigger by determining a threshold frequency of use allowed for the first vector chunk based on the first condition and comparing the threshold frequency to a current frequency of use of the first vector chunk. For example, the system may determine whether to subject the first vector chunk to the first processing request by evaluating the threshold frequency of use specified in the first usage trigger and comparing it to the current frequency of use of the vector chunk. The process begins with the system retrieving the usage trigger associated with the vector chunk, which includes a condition defining the maximum allowable frequency of use within a specific time period. This threshold frequency may be designed to prevent overuse of the vector chunk or ensure its relevance to the intended applications. The system then calculates the current frequency of use for the vector chunk by analyzing its usage metadata. This metadata typically tracks timestamps or counters for recent accesses, allowing the system to compute how often the vector chunk has been used within the defined time frame. By comparing the current frequency of use to the threshold frequency, the system determines whether the vector chunk remains within its allowable usage limits. If the current frequency is below the threshold, the system considers the vector chunk eligible for the processing request and proceeds to use it. However, if the frequency exceeds the threshold, the system excludes the vector chunk from the request, ensuring compliance with the usage trigger. This approach helps the system manage vector chunk utilization effectively, avoiding excessive use that could lead to degraded performance or outdated relevance. By dynamically enforcing frequency-based conditions, the system maintains optimal performance, ensures data validity, and supports efficient resource allocation.

In some embodiments, the system may determine whether to subject the first vector chunk to the first processing request based on the first usage trigger by determining an embedding format of the first vector chunk based on the first condition and comparing the embedding format to a characteristic of the first processing request. For example, the system may determine whether to subject the first vector chunk to the first processing request by evaluating the embedding format specified in the first usage trigger and comparing it to a characteristic of the processing request. The process begins with the system retrieving the usage trigger associated with the vector chunk, which may include conditions specifying the embedding format used to generate the vector. Embedding formats refer to the specific method or model used to encode the data into a vector, such as text embeddings, image embeddings, or specialized domain-specific embeddings (e.g., BERT, ResNet, or custom embeddings). The system then examines the characteristic of the processing request, such as the type of data being processed, the model required for computation, or the similarity search method to be applied. By comparing the embedding format of the vector chunk to the characteristic of the processing request, the system determines whether the vector chunk is compatible with the requested operation. For example, if the processing request involves a textual similarity search, the system verifies that the vector chunk was generated using a text embedding model and not an incompatible format like an image embedding model. If the embedding format aligns with the requirements of the processing request, the system deems the vector chunk suitable for use and includes it in the operation. Conversely, if the embedding format does not match the characteristics of the request, the vector chunk is excluded to prevent errors or irrelevant results. This evaluation ensures that the system processes vector chunks only when they are contextually and technically compatible with the intended task, maintaining both accuracy and efficiency in its operations.

In some embodiments, the system may determine whether to subject the first vector chunk to the first processing request based on the first usage trigger by determining a first retention priority for the first vector chunk based on the first condition and comparing the first retention priority to a second retention priority for a second vector chunk. For example, the system may determine whether to subject the first vector chunk to the first processing request by evaluating its retention priority in comparison to other vector chunks, such as a second vector chunk. The process begins with the system retrieving the first usage trigger associated with the first vector chunk, which specifies a condition for determining its retention priority. Retention priority is a measure of how critical or relevant a vector chunk is for ongoing or future tasks, and it may be based on factors such as frequency of use, recency of access, contextual relevance, or metadata indicators like tags or source importance. The system calculates the first retention priority for the first vector chunk by analyzing these factors and assigns it a priority score or level. Similarly, the system calculates the second retention priority for the second vector chunk, applying the same criteria. It then compares the first and second retention priorities to assess their relative importance. If the first vector chunk has a higher or equal retention priority compared to the second vector chunk, the system determines that it should be subjected to the first processing request. Conversely, if the second vector chunk has a higher retention priority, the system may prioritize its use instead and exclude the first vector chunk from the operation. This comparative evaluation allows the system to manage resources effectively, ensuring that the most relevant and valuable data is prioritized for processing. By incorporating retention priorities into the decision-making process, the system optimizes performance, maintains data relevance, and supports efficient utilization of storage and computational resources.

At step 412, process 400 (e.g., using one or more components described above) executes the processing request. For example, the system may execute the first processing request using the first vector chunk based on determining to subject the first vector chunk to the first processing request. As an example, when a system determines to subject the first vector chunk to the first processing request, it executes the request by leveraging the vector chunk's stored data and associated metadata. The system may retrieve the vector chunk from the cache, ensuring it meets the conditions specified by its usage trigger, such as validity, relevance, or contextual applicability. Once retrieved, the vector chunk, which includes its high-dimensional vector representation, is passed to the appropriate computational module or processing pipeline. For instance, in a similarity search application, the vector chunk may be compared to a query vector to compute similarity scores using algorithms like cosine similarity or Euclidean distance. The system then uses these scores to rank the chunk's relevance to the query. If the processing request involves additional operations, such as combining results from multiple vector chunks or retrieving source data linked to the vector chunk, the system integrates these tasks into the execution flow. The metadata associated with the vector chunk, such as its source, tags, or context, may also be used to refine or filter the output. Finally, the system generates a response based on the processed data and delivers it to the requesting user or system. This approach ensures that the execution is efficient, context-aware, and aligned with the specific requirements of the processing request while optimizing the use of cached resources.

In some embodiments, the system executes the first processing request using the first vector chunk by determining a search query term corresponding to the first processing request and comparing the search query term to the first processing request. For example, the system executes the first processing request using the first vector chunk by determining a search query term corresponding to the request and comparing it to the content or metadata of the vector chunk. This process begins with the system analyzing the first processing request to extract or derive a search query term that encapsulates the request's intent. For instance, if the request involves finding similar documents or data, the system may encode the query input into a vector representation or identify specific keywords or phrases from the request. Next, the system compares the derived search query term to the first vector chunk by evaluating its relevance. This comparison may involve matching the query term against the vector chunk's metadata, such as tags, source information, or keywords, to determine alignment. Alternatively, the system can encode the query term into a vector using the same embedding model as the vector chunk and compute similarity scores using techniques like cosine similarity or Euclidean distance. If the search query term and the vector chunk demonstrate a sufficient level of relevance or similarity based on predefined thresholds, the system deems the vector chunk suitable for the request. Finally, the system uses the selected vector chunk to execute the processing request, such as retrieving associated data, generating recommendations, or returning query results. By aligning the query term with the vector chunk's content and context, the system ensures that the processing request is fulfilled accurately and efficiently, leveraging the vector chunk's stored data to deliver meaningful outcomes.

In some embodiments, the system executes the first processing request using the first vector chunk by determining a data cleansing operation corresponding to the first processing request and removing the first vector chunk from the first vector cache with the data cleansing operation. This process may begin with the system receiving the first processing request, which is analyzed to identify its purpose. If the request is determined to be a data cleansing operation, such as removing outdated, irrelevant, or unused vector chunks, the system evaluates the vector chunk against predefined criteria or usage triggers. These criteria may include conditions like a Time-to-Live (TTL) expiration, infrequent access, or a mismatch with the current context or dataset. Once the system identifies that the first vector chunk meets the criteria for removal, it executes the data cleansing operation by deleting the vector chunk from the vector cache. This deletion is managed by the vector cache manager, which ensures that the operation is performed efficiently and without disrupting other ongoing processes. Metadata associated with the vector chunk may also be used during this process to log the operation or inform downstream systems of the cleansing activity. By executing the data cleansing operation in response to the first processing request, the system ensures that the vector cache remains optimized, storing only relevant and active data, while freeing up resources for new or more critical information. This approach enhances the overall efficiency and scalability of the system without compromising data integrity or performance.

In some embodiments, the system may execute the first processing request using the first vector chunk by comparing, using a data integrity protocol, the first vector chunk in the first vector cache to data remaining in the first vector database, determining that the first vector chunk in the first vector cache does not correspond to data remaining in the first vector database, and removing the first vector chunk from the first vector cache based on determining that the first vector chunk in the first vector cache does not correspond to the data remaining in the first vector database. For example, the system may initiate a comparison operation as part of the data integrity protocol. The system retrieves the first vector chunk from the first vector cache and compares it to the corresponding data in the first vector database. This comparison may involve checking unique identifiers, timestamps, hash values, or other integrity markers to verify that the cached vector chunk matches the most up-to-date version stored in the database. If the system determines that the first vector chunk in the cache does not correspond to the data remaining in the vector database—such as when the database entry has been updated, deleted, or no longer exists—the system flags the cached vector chunk as stale or invalid. Based on this determination, the system, via the vector cache manager, removes the first vector chunk from the cache to prevent the use of outdated or irrelevant data in subsequent operations. This cleansing operation ensures that the cache remains consistent with the database, maintaining the integrity of the data used for processing requests. By executing this process, the system ensures that the first vector cache only contains valid and relevant vector chunks, optimizing its performance and ensuring accurate, up-to-date responses for future processing requests. This approach prevents inconsistencies between the cache and the database from leading to incorrect outputs, thereby upholding the reliability and accuracy of the system.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure.

For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for reducing data storage requirements across computer networks.
2. The method of any one of the preceding embodiments, further comprising: receiving, from a first vector database, a first vector chunk; storing, in a first vector cache, the first vector chunk;
receiving a first processing request; while the first vector chunk is in the first vector cache, retrieving a first usage trigger from the first vector chunk, wherein the first usage trigger indicates a first condition for using the first vector chunk; determining, by a vector cache manager, whether to subject the first vector chunk to the first processing request based on the first usage trigger; and executing the first processing request using the first vector chunk based on determining to subject the first vector chunk to the first processing request.
3. The method of claim 2, wherein executing the first processing request using the first vector chunk further comprises: determining a search query term corresponding to the first processing request; and comparing the search query term to the first processing request.
4. The method of claim 2, wherein executing the first processing request using the first vector chunk further comprises: determining a data cleansing operation corresponding to the first processing request; and removing the first vector chunk from the first vector cache with the data cleansing operation.
5. The method of claim 2, wherein executing the first processing request using the first vector chunk further comprises: comparing, using a data integrity protocol, the first vector chunk in the first vector cache to data remaining in the first vector database; determining that the first vector chunk in the first vector cache does not correspond to data remaining in the first vector database; and removing the first vector chunk from the first vector cache based on determining that the first vector chunk in the first vector cache does not correspond to the data remaining in the first vector database.
6. The method of claim 2, wherein determining whether to subject the first vector chunk to the first processing request based on the first usage trigger further comprises: determining an expiration date for the first vector chunk based on the first condition; and comparing the expiration date to a current date.
7. The method of claim 2, wherein determining whether to subject the first vector chunk to the first processing request based on the first usage trigger further comprises: determining an allowed use for the first vector chunk based on the first condition; and comparing the allowed use to the first processing request.
8. The method of claim 2, wherein determining whether to subject the first vector chunk to the first processing request based on the first usage trigger further comprises: determining a threshold number of uses allowed for the first vector chunk based on the first condition; and comparing the threshold number of uses to a previous number of uses of the first vector chunk.
9. The method of claim 2, wherein determining whether to subject the first vector chunk to the first processing request based on the first usage trigger further comprises: determining a threshold frequency of use allowed for the first vector chunk based on the first condition; and comparing the threshold frequency to a current frequency of use of the first vector chunk.
10. The method of claim 2, wherein determining whether to subject the first vector chunk to the first processing request based on the first usage trigger further comprises: determining an embedding format of the first vector chunk based on the first condition; and comparing the embedding format to a characteristic of the first processing request.
11. The method of claim 2, wherein determining whether to subject the first vector chunk to the first processing request based on the first usage trigger further comprises: determining a first retention priority for the first vector chunk based on the first condition; and comparing the first retention priority to a second retention priority for a second vector chunk.
12. The method of claim 2, wherein retrieving the first usage trigger from the first vector chunk, wherein the first usage trigger indicates the first condition for using the first vector chunk further comprises: parsing source code of the first vector chunk; and identifying the first condition in the source code.
13. The method of claim 2, wherein retrieving the first usage trigger from the first vector chunk, wherein the first usage trigger indicates the first condition for using the first vector chunk further comprises: parsing source code of the first vector chunk; and identifying a first pointer in the source code, wherein the first pointer references an auxiliary database comprising the first condition.
14. The method of claim 2, wherein retrieving the first usage trigger from the first vector chunk, wherein the first usage trigger indicates the first condition for using the first vector chunk further comprises: parsing source code of the first vector chunk; and identifying a first characteristic in the source code to determine the first condition.
15. The method of claim 2, wherein retrieving the first usage trigger from the first vector chunk, wherein the first usage trigger indicates the first condition for using the first vector chunk further comprises: parsing source code of the first vector chunk; identifying a first rule in the source code; and executing the first rule to determine the first condition.
16. The method of claim 2, wherein retrieving the first usage trigger from the first vector chunk, wherein the first usage trigger indicates the first condition for using the first vector chunk further comprises: parsing source code of the first vector chunk; identifying a first data source in the source code; and using the first data source to determine the first condition.
17. One or more non-transitory, computer-readable mediums storing instructions that, when executed by a data processing apparatus, cause the data processing apparatus to perform operations comprising those of any of embodiments 1-16.
18. A system comprising one or more processors; and memory storing instructions that, when executed by the processors, cause the processors to effectuate operations comprising those of any of embodiments 1-16.
19. A system comprising means for performing any of embodiments 1-16.

1. A system for reducing data storage requirements across computer networks by pruning or cleansing outdated or unused data from vector databases, the system comprising:
one or more processors; and
one or more non-transitory, computer-readable media, comprising instructions that, when executed by the one or more processors, cause operations comprising:
receiving, via a user interface, a processing request of a plurality of processing requests from a network device of a computer network, wherein the processing request is received from the network device as an application programming interface call;
in response to the processing request, parsing the processing request to extract a parameter;
validating the processing request based on the parameter to generate a processed input;
routing the processed input to an internal module correspond to a database manager;
using the database manager to access, from a vector database, a vector chunk from a plurality of vector chunks in the vector database, wherein the vector chunk comprises a vector representation of data;
caching, in a vector cache, the vector chunk;
while the vector chunk is cached in the vector cache, retrieving a key-value pair from the vector chunk, wherein the key-value pair indicates a condition for using the vector chunk; and
cleansing, by a vector cache manager, the vector chunk from the vector cache based on the key-value pair.

2. A method for reducing data storage requirements across computer networks by pruning or cleansing outdated or unused data from vector databases, the method comprising:
receiving, from vector database, a first vector chunk and a second vector chunk, wherein the first vector chunk comprises a first vector representation of data, and wherein the second vector chunk comprises a second vector representation of data;
storing, in a vector cache, the first vector chunk without the second vector chunk;
receiving a first processing request of a plurality of processing requests;
while the first vector chunk is in the vector cache, retrieving a first usage trigger from the first vector chunk, wherein the first usage trigger indicates a first condition for using the first vector chunk;
determining, by a vector cache manager, that the first vector chunk corresponds to the first processing request based on the first usage trigger; and
executing the first processing request using the first vector chunk by:
determining a data cleansing operation corresponding to the first processing request; and
removing the first vector chunk from the vector cache with the data cleansing operation.

3. The method of claim 2, wherein executing the first processing request using the first vector chunk further comprises:
determining a search query term corresponding to the first processing request; and
comparing the search query term to the first processing request.

4. (canceled)

5. The method of claim 2, wherein executing the first processing request using the first vector chunk further comprises:
comparing, using a data integrity protocol, the first vector chunk in the first vector cache to data remaining in the vector database;
determining that the first vector chunk in the vector cache does not correspond to data remaining in the vector database; and
removing the first vector chunk from the vector cache based on determining that the first vector chunk in the vector cache does not correspond to the data remaining in the vector database.

6. The method of claim 2, wherein determining whether to subject the first vector chunk to the first processing request based on the first usage trigger further comprises:
determining an expiration date for the first vector chunk based on the first condition; and
comparing the expiration date to a current date.

7. The method of claim 2, wherein determining whether to subject the first vector chunk to the first processing request based on the first usage trigger further comprises:
determining an allowed use for the first vector chunk based on the first condition; and
comparing the allowed use to the first processing request.

8. The method of claim 2, wherein determining whether to subject the first vector chunk to the first processing request based on the first usage trigger further comprises:
determining a threshold number of uses allowed for the first vector chunk based on the first condition; and
comparing the threshold number of uses to a previous number of uses of the first vector chunk.

9. The method of claim 2, wherein determining whether to subject the first vector chunk to the first processing request based on the first usage trigger further comprises:
determining a threshold frequency of use allowed for the first vector chunk based on the first condition; and
comparing the threshold frequency to a current frequency of use of the first vector chunk.

10. The method of claim 2, wherein determining whether to subject the first vector chunk to the first processing request based on the first usage trigger further comprises:
determining an embedding format of the first vector chunk based on the first condition; and
comparing the embedding format to a characteristic of the first processing request.

11. The method of claim 2, wherein determining whether to subject the first vector chunk to the first processing request based on the first usage trigger further comprises:
determining a first retention priority for the first vector chunk based on the first condition; and
comparing the first retention priority to a second retention priority for a second vector chunk.

12. The method of claim 2, wherein retrieving the first usage trigger from the first vector chunk, wherein the first usage trigger indicates the first condition for using the first vector chunk further comprises:
parsing source code of the first vector chunk; and identifying the first condition in the source code.

13. The method of claim 2, wherein retrieving the first usage trigger from the first vector chunk, wherein the first usage trigger indicates the first condition for using the first vector chunk further comprises:
parsing source code of the first vector chunk; and
identifying a first pointer in the source code, wherein the first pointer references an auxiliary database comprising the first condition.

14. The method of claim 2, wherein retrieving the first usage trigger from the first vector chunk, wherein the first usage trigger indicates the first condition for using the first vector chunk further comprises:
parsing source code of the first vector chunk; and
identifying a first characteristic in the source code to determine the first condition.

15. The method of claim 2, wherein retrieving the first usage trigger from the first vector chunk, wherein the first usage trigger indicates the first condition for using the first vector chunk further comprises:
parsing source code of the first vector chunk; identifying a first rule in the source code; and executing the first rule to determine the first condition.

16. The method of claim 2, wherein retrieving the first usage trigger from the first vector chunk, wherein the first usage trigger indicates the first condition for using the first vector chunk further comprises:
parsing source code of the first vector chunk; identifying a first data source in the source code; and
using the first data source to determine the first condition.

17. One or more non-transitory, computer-readable media, comprising instructions that, when executed by one or more processors, cause operations comprising:
receiving, from a vector database, a first vector chunk and a second vector chunk, wherein the first vector chunk comprises a first vector representation of data, and wherein the second vector chunk comprises a second vector representation of data;
storing, in a vector cache, the first vector chunk without the second vector chunk;
receiving a first processing request of a plurality of processing requests;
while the first vector chunk is in the vector cache, retrieving a first usage trigger from the first vector chunk, wherein the first usage trigger indicates a first condition for using the first vector chunk;
determining, by a vector cache manager, to subject the first vector chunk to the first processing request based on the first usage trigger; and
executing the first processing request to prune or cleanse outdated or unused data from vector databases using the first vector chunk first by:
comparing, using a data integrity protocol, the first vector chunk in the vector cache to data remaining in the vector database;
determining that the first vector chunk in the vector cache does not correspond to data remaining in the vector database; and
removing the first vector chunk from the vector cache based on determining that the first vector chunk in the vector cache does not correspond to the data remaining in the vector database.

18. The one or more non-transitory, computer-readable media of claim 17, wherein executing the first processing request using the first vector chunk further comprises:
determining a search query term corresponding to the first processing request; and comparing the search query term to the first processing request.

19. The one or more non-transitory, computer-readable media of claim 17, wherein executing the first processing request using the first vector chunk further comprises:
determining a data cleansing operation corresponding to the first processing request; and
removing the first vector chunk from the vector cache with the data cleansing operation.

20. (canceled)

21. The method of claim 2, wherein retrieving the first usage trigger from the first vector chunk, wherein the first usage trigger indicates the first condition for using the first vector chunk further comprises:
parsing source code of the first vector chunk; and
identifying a first characteristic in the source code to determine the first condition.

22. The method of claim 2, wherein retrieving the first usage trigger from the first vector chunk further comprises:
determining a second condition for using the first vector chunk; and
comparing the second condition to the vector cache.
